(19) United States
(12) Patent Application Publication
(10) Pub. No.: US 2007/0143691 A1
(43) Pub. Date: Jun. 21, 2007

(54) Method for conducting a clinical study

(76) Inventors: Klaus Abraham-Fuchs, Erlangen (DE); Rainer Kuth, Hochstadt (DE); Eva Rumpel, Erlangen (DE); Markus Schmidt, Nurnberg (DE); Siegfried Schneider, Erlangen (DE); Horst Schreiner, Furth (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/589,535

(22) PCT Filed: Feb. 7, 2005
(86) PCT No.: PCT/EP05/50517

§ 371 Date: Aug. 16, 2006

(30) Foreign Application Priority Data
Feb. 18, 2004 (DE) 10 2004 008 196.4
Oct. 28, 2004 (DE) 10 2004 052 539.0

(51) Int. Cl. G06F 17/00; G06F 3/00; G06Q 10/00; G06Q 40/00

(52) U.S. Cl. 715/751; 715/733; 705/2; 705/4

(57) ABSTRACT

A method is disclosed for conducting a clinical study according to which an event occurs during the study that requires a collaboration of individuals responsible for the study. The method includes transmitting the event to a collaboration system. The collaboration system determines, based on parameters assigned to the event, a group of individuals responsible for the study required for the collaboration. The collaboration system provides a communications platform for the group. The group carries out the collaboration while using the communications platform. Finally, the collaboration system verifies the collaboration on the basis of predetermined verification criteria.

This application is the national phase under 35 U.S.C. § 371 of PCT International Application No. PCT/EP2005/050517 which has an International filing date of Feb. 7, 2005, which designated the United States of America and which claims priority on German Patent Applications number DE 10 2004 008 196.4 filed Feb. 18, 2004, and number DE 10 2004 052 539.0 filed Oct. 28, 2004, the entire contents of each of which are hereby incorporated herein by reference.

### FIELD

The invention generally relates to a method for conducting a clinical study.

### BACKGROUND

Clinical studies are performed, for example, to test new medicines, surgical interventions, treatments, or diagnostic devices in a large number of patients. They are initiated and carried out by various financial backers and commissioning organizations or sponsors, such as pharmaceutical companies, hospitals, or state bodies. The aim is usually to register the tested product with a state body. Anywhere from just a few to several thousand patients take part in these studies, depending on the type of study.

There are many responsible personnel in charge of the design, development, and, in particular, the performance of a clinical study. These responsible study personnel are study directors, attending physicians, researchers, and laboratory or other hospital staff, consulting specialists or administrative staff.

For the performance of the clinical study in the patients, there are extremely detailed instructions or treatment rules which are laid down in the study protocol or the so-called SOPs (Standard Operating Procedures), e.g. the procedure for measuring a patient's blood pressure.

For the organizational or administrative performance of the clinical study, on the other hand, there are not usually any detailed guidelines or specified procedures. Again and again, however, during the course of a clinical study, events occur which call for cooperation, coordination, expert discussion, etc. on the part of responsible study personnel, i.e. their collaboration. These can be events that were planned in advance, e.g. half-yearly meetings of all study doctors, as prescribed in the study protocol. However, they can also be unforeseen situations, e.g. the occurrence of side effects in a number of patients within a short space of time. Such cases call for consultation with outside experts and study doctors, for example, in order to clarify whether the side effects are connected with the study.

To protect the patients—and because a clinical study involves a heavy financial outlay on the part of the financial backer or commissioning organization—any unforeseen event must be investigated as quickly as possible to ascertain whether the study should go on or be discontinued.

Collaboration between responsible study personnel is made more difficult by numerous framework conditions: it is necessary to establish which people are needed for a discussion and a decision on a particular event, who has the necessary competence, when and where the people are available, how they can be contacted, i.e. what means of communication (telephone, fax, internet connection) they have available to them for taking part in the collaboration, and which people may also be useful for collaboration, e.g. GPs, who are not listed as responsible study personnel, but may be consulted by patients in an emergency.

Since there are no detailed specifications regarding the course of the study, many responsible study personnel are often unsure about entire study process, e.g. what discussions and decisions are necessary or appropriate and when, what information about a particular problem is already available or the earliest time at which it will be available, e.g. interim analyses from studies, patient data, etc.

Currently, all these deliberations and actions take place only when required and often not within an acceptable timeframe or with an acceptable level of resources. Because of the sometimes uncoordinated way in which things are done, a lot of information is lost and work is duplicated. Not everyone for whom a certain piece of information is relevant receives it, because, for example, they are not invited to a discussion or are not informed of its result. Important intermediate administrative steps in processes are forgotten.

All this has an adverse impact on the quality of the clinical study, its efficiency, and thus its duration and cost. In the case of the registration of a new drug, for example, a single day's delay in a clinical study can lead to a substantial financial loss for the pharmaceutical company financing it.

### SUMMARY

In at least one embodiment of the present invention, an improved method is disclosed for conducting a clinical study.

A method is disclosed for conducting a clinical study in which the occurrence of an event during the study necessitates collaboration between responsible study personnel. The method contains the following steps: The event is communicated to a collaboration system. The collaboration system, on the basis of parameters assigned to the event, identifies a group of responsible study personnel who are needed for the collaboration. The collaboration system provides a communications platform for the group. The group undertakes the collaboration using the communications platform. The collaboration system checks the collaboration on the basis of pre-established verification criteria.

Collaboration is understood to mean any form of cooperation, i.e. written or verbal exchange of opinions, agreements, exchange or communication of knowledge, findings, or opinions. Responsible study personnel are not only persons in charge of the design, preparation, performance, or evaluation of the study, but can also be data processing systems, such as a hospital administration system, a knowledge database, or the like. The collaboration system can for example be an electronic data processing or administration system or a service provider in charge of the performance of the clinical study or an individual person or a group of persons.

All event-related data, striking features, and opinions and statements of responsible study personnel or patients etc. which seem relevant for handling of the event by the responsible study personnel, e.g. patient data, laboratory values, or observations by study doctors, can be parameters assigned to the event. A meeting site, telephone, email, and fax connections, videoconferencing, or written correspondence, in each case alone or in combination with each other, can be used as a communications platform. Verification criteria are, for example, the time and duration of collaboration, actual participants, the result arrived at, or the information exchanged.

The continuous process chain from the communication of the event to the collaboration system to the checking of collaboration ensures the following: the event is actually dealt with, cannot be forgotten or overlooked, and is evaluated by the responsible study personnel in regard to the study, i.e. the event's effects on the study are determined. The collaboration must actually take place. All the responsible study personnel affected are informed and participate in dealing with the event, no-one is forgotten or not told about it. The actual performance of each individual process step can be validated by way of the verification criteria.

Similar events can dealt with in a similar manner by the collaboration system, and consistency within the clinical study is thereby increased. As the central organ of the clinical study, the collaboration system is informed of all events that occur. Thus, the same or similar events are not dealt with twice or dealt with in different ways.

The collaboration system relieves the responsible study personnel of time-consuming jobs such as identifying and contacting the relevant people to talk to, choosing the method/device/system of communication, and arranging the time and place of collaboration activities.

The responsible study personnel can take part in the collaboration via the information channels and can do this whilst being or remaining in different places, without having to travel to a common meeting-place. This saves time and money in respect of the implementation of collaboration.

Process specifications can be set up in the collaboration system in advance and in a uniform manner for certain classes of events; intermediate steps in process sequences can thus no longer be forgotten. Thus, for each event, it is possible to establish and implement a clear, fixed procedure, as a result of which the uniformity and comparability of a clinical study are increased. The time taken to respond to events is reduced. The checking provides a control mechanism for the collaboration, which ensures that the collaboration is actually carried out in accordance with the required framework.

As a result of the aforementioned advantages, the quality of the clinical study is increased and the study can be carried out more effectively and the duration—and thus the cost—of the study reduced. The quality and results of the study are measurable, thereby also allowing conclusions about the quality of the clinical study.

To effect the collaboration, the collaboration system can provide a central information bus and provide each responsible study personnel member of the group with an information channel to the information bus. The information channel can be a telephone connection, a fax connection, an internet connection, or some other communication connection whereby the responsible study personnel member is able to establish contact with the information bus. The information bus itself can, for example, be a simple central switchboard which connects various telephone participants, or an information processing system which can convey information that one responsible study personnel member supplies to the bus in the form of a written communication for example, verbally to another responsible study personnel member via a telephone line, i.e. which can convert information between different communication systems. The advantage of this is that all of the collaboration takes place on the information bus, to which the collaboration system has access. It thus also has access to all information exchanged as part of the collaboration. Complete collaboration can be checked by the collaboration system.

The collaboration system can use the parameters assigned to the event to ascertain available data needed for collaboration that are in a database containing medical knowledge or in a study database. It can extract the data from the database and make them available to the group on the communications platform.

The data represent background information, supplementary information, decision-making aids, etc. for the collaboration. By having access to the communications platform, the responsible study personnel taking part in the collaboration thus have access to the data provided. Since the data are specifically ascertained for the event by the collaboration system, the amount of data can be restricted from the start, enabling the responsible study personnel to familiarize themselves with the data, or examine the data, quickly. The data can be prepared and presented on the communications platform in a suitably clear and comprehensible way by the collaboration system. It does away with the need for laborious, time-consuming selection of appropriate data by the responsible study personnel. The data can be assembled before the collaboration if this requires lengthy statistical evaluations for example. The requisite data are then available at the time of collaboration.

The collaboration system can also use the parameters assigned to the event to establish a content and time framework for the collaboration and to communicate this to the group.

A content framework is, for example, one concerned with what circumstances the group has to make a decision about or what information absolutely has to be exchanged between the participants. The time framework describes, for example, when information must be exchanged, by when this must be completed, and by when a certain decision must be made. The content and time targets enable the collaboration to be carried out in a rapid, focused, and effective manner. They ensure that decisions/discussions are taken/completed at pre-established times, which in turn allows other process steps that need to be taken as part of the clinical study to take place promptly.

A clinical study can be carried out in a particularly structured way if the collaboration system uses the content or time framework as a verification criterion and, when the collaboration is over, checks compliance with the verification criteria. At the end of the collaboration an assessable or evaluateable result of the collaboration is thus available, and, on the basis of the compliance or noncompliance with the verification criteria, the clinical study can be continued in a clear and structured way. The results may, for example, be entered on the study database, a message may be sent to the study director, or other procedures may be determined, e.g. fresh collaboration instituted.

The parameters assigned to an event often reveal connections with knowledge, findings, etc. which have hitherto not been taken into account in the study. The range of knowledge available in the study for the purposes of collaboration can therefore be increased if people who were not involved in the study prior to the occurrence of the event are included in the group, and thus in the study, as responsible personnel.

The event can be a prompt for collaboration which is defined within the framework of the study. These are thus planned collaborations, which are definable even before the start of the study. The distribution of tasks, participants, content targets, and time framework can be defined beforehand. The course of such collaboration can thus be taken into account and planned as early as at the study design stage.

In an alternative variant of the method the event is an unforeseeable event arising during the study. Here too the infrastructure provided by the collaboration system, i.e. the mode of procedure, communications platform, and checking of collaboration, ensures that the event is dealt with in a rapid, effective, and focused way.

If the event is found by a monitoring system combing through the study database data for anything striking, then irregularities and odd features, e.g. disease symptoms occurring in parallel at different clinics, which would otherwise have gone unheeded as they were not picked up by the responsible study personnel themselves, can be dealt with promptly. The monitoring system can be a database system or a person tasked with the job of searching through the study database. If, for example, the study data are compared with a medical knowledge database, medical connections which are already recorded in the database but which have not yet been noted in the clinical study may also trigger an event that warrants discussion. The clinical study is thus informed by, and can draw on, all knowledge stored in the medical knowledge database.

If the collaboration is documented, then all the framework data on the collaboration, such as its start, end, result, participants, and the reason for the collaboration, are recorded and can be viewed again at any time.

If the collaboration is archived, then, for example, all the discussions, exchanged documents, emails, letters, etc. are stored in their full form, such that it is subsequently possible to trace back the precise words used in a telephone conversation for example. As a result, the course of a clinical study remains reconstructable or reproducible to any desired level of detail, and the study can be better compared with other studies or other medical findings. The results of collaboration can thus be accessed at any time. Data and information cannot get lost.

### BRIEF DESCRIPTION OF THE DRAWINGS

For a further description of the invention, reference is made to the illustrative embodiments in the drawings, which are both diagrammatic sketches.

FIG. 1 shows the course of a clinical study in which an unforeseen event occurs and triggers collaboration;

FIG. 2 shows the course of the clinical study in FIG. 1 in which a planned event triggers collaboration.

### DETAILED DESCRIPTION OF THE EXAMPLE EMBODIMENTS

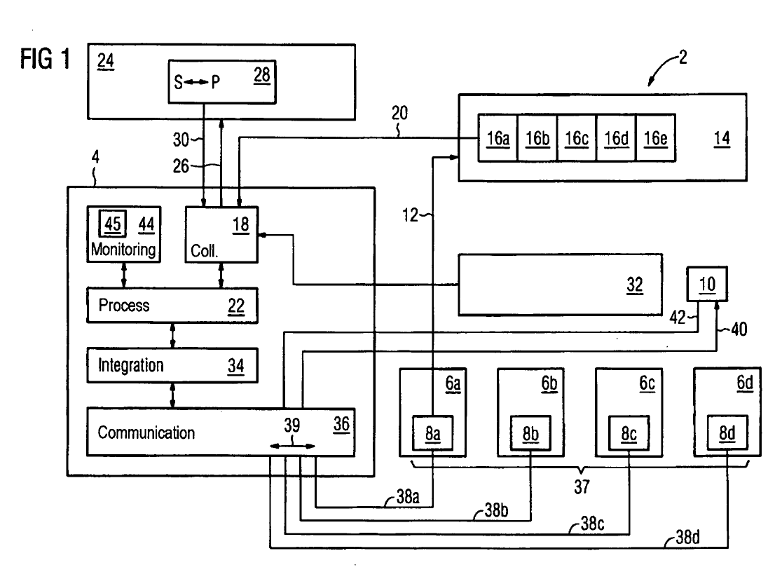

FIG. 1 shows a clinical study 2 which has been assigned a collaboration system 4. The clinical study 2 is represented by four hospitals 6a-d in which a total of 200 patients (not shown) are cared for as study participants. Each hospital 6a-d has a study doctor 8a-d assigned to it as a responsible study personnel member. The study 2 as a whole is managed by a study director 10. All the data of the clinical study are or will be stored in a study database 32.

During the performance of the study 2, an unforeseen event 14 occurs: four of the patients or study participants cared for by doctor 8a at clinic 6a suddenly require inpatient treatment as they all exhibit symptom S. Doctor 8a thereupon formulates, as indicated by the arrow 12, the event 14, to which he assigns the parameters 16a-e, namely:

notification by doctor 8a

clinic 6a

the symptom that occurred is symptom S

four patients, A-D, are affected

on date x.

The collaboration system 4 has a modular structure. A collaboration module is always in readiness to identify events received and is responsible for directing all the collaboration. A process module 22 contains all information about processes that take place during the study 2, i.e. about the precise performance of the study 2 or its execution. An integration module 34 can convert data in very different formats into each other. A communication module 36 provides the option of connection to every conceivable communication device. A monitoring module 44 monitors all processes taking place in the collaboration system 4. All the modules are interlinked and can exchange data and information in any way required.

Via the signal 20, the event 14 together with the parameters 16a-e is communicated to the collaboration module 18. The collaboration module 18 communicates the event 14 to the process module 22. The process module 22 classifies the event 14 and selects an appropriate method for dealing with the event 14. The method may either already be stored in the process module or may only be created when the need arises. Since the event belongs to the class of “Unforeseen symptoms in patients”, the process module 22 communicates, to the collaboration module 18, a process chain which has to be worked through:
clarification of whether the event 14 is connected with the study,
decision as to whether the study should go on or be discontinued,
the time frame is 12 hours,
the participants are doctor 8a and all the doctors corresponding to him at the clinics 6b-d,
provision of background information if possible,
notification of the study director 10 after the collaboration 39 is over.

To provide background information, the collaboration module 18 orders: processing of the symptom S and of patient data of the four sick patients from the study database 32 (arrow 19) by the integration module 22 for a database query and transmission of the query to a medical database 24, indicated by the arrow 26. As a result of the query 26, the database 24 delivers a report 28, in which the symptom “S” is linked to a parameter “P” which is medically measurable in the patient. The result of the database query is transferred to the collaboration module 18 (arrow 30).

Since the parameter “P” is important for the discussion to be initiated between the responsible study personnel 8a-d, the collaboration module 18 orders that the parameter “P” for all four affected patients be read from the study database 32 and be transferred, with the report 28, to the integration module 34. In the integration module 34, the electronic formats of the parameters “P” and the report 28 are converted into uniform formats and made available to the communications platform 36 as background information.

The collaboration system 18 establishes doctors 8b-d as the doctors on the same level as doctor 8a and, from these and doctor 8a, forms the group 37. To bring the group 37 of responsible study personnel together for the collaboration 39, the collaboration module 18 establishes from the study database 32 that doctors 8a and b can be contacted by landline telephone, 8c by mobile, and 8d via a multimedia internet PC. The collaboration module 18 accordingly proceeds to connect doctors 8a and b to the communications platform 36 via landline 38a,b, doctor 8c via the mobile network 38c, and doctor 8d via the internet 38d. Since all four participants in the discussion are contactable at this time, the connection is established eight hours after the receipt of the event 14. The collaboration module informs the group 37 that they have 4 hours left to make a decision and what needs to be discussed and presents the report 28, together with the patient data, as background information.

The doctors 8a-d undertake the collaboration 39 via the communications platform 36, discussing the connection between the symptom “S” and the clinical study 2 on the basis of the available patient parameters and the report 28. When the collaboration 39 is over, the doctors 8a-d communicate the result of their collaboration 39 to the collaboration module 18. In their opinion, the clinical study 2 must be discontinued immediately, as the symptoms “S” are critical and are likely to occur in very many other patients also. The collaboration module 18, via the signal path 40, thereupon immediately alerts the study director 10—namely by activating his pager—to get in touch with the communications platform 36 as a matter of urgency.

The integration module 34 has in the meantime summarized the results of the discussion from the collaboration 39 of doctors 8a-d in a document and made it available on the collaboration platform 36, from where the study director 10 accesses it via the data line 42, studies the document, and discontinues the clinical study 2 with immediate effect.

Alternatively, the result of the collaboration 39 may be that the group 37 of doctors 8a-d concludes that the symptoms “S” are not connected with the clinical study 2. In this case the collaboration system 18 informs the study director 10 of the collaboration 39 by post, which is likewise indicated by the arrow 40. For this, the integration module 34 summarizes the results of the collaboration 39 in a printable document, which is printed out and dispatched bearing the postal address of the study director 10.

All the steps and processes in the collaboration system 4 are constantly monitored and recorded by the monitoring module 44. The verification criterion 45 stored in the monitoring module 44 is compliance of the collaboration 39 with the content framework in which the results of the collaboration are checked against the process specifications. Compliance with the 12-hour time window between the occurrence of the event 14 and the taking of a decision by the group 37 is another verification criterion 45. In addition, all communication processes and exchanged data are archived, so that the collaboration 39 and decision-making of the group 37 is reconstructable at a later time. The occurrence of the event 14 is recorded with the time and date and filed in the study database 32.

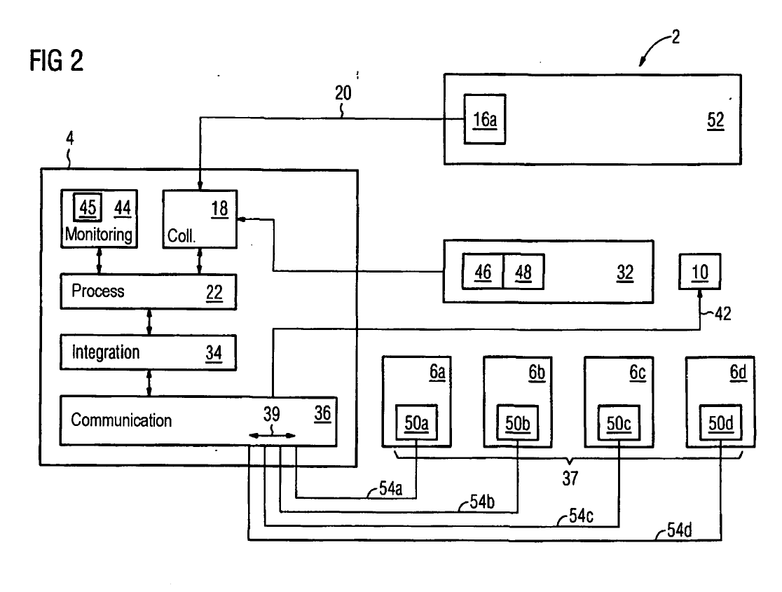

FIG. 2 shows, once again, the clinical study 2 from FIG. 1 with the assigned collaboration system 4. The responsible study personnel shown for the situation depicted here, however, are the radiologists 50a-d employed at the four clinics 6a-d, who perform MRI scans 48 on all the study participants, i.e. patients, every month during the study 2 in order to check and measure deposits in the vessels. For this, four different MRI scanners (not shown) are in use at the four hospitals 6a-d. The measure of the deposition is a deposition parameter “P” 46 that can be determined from the MRI scans. The scans 48 and the parameters 46 are filed in the study database 32.

Before the start of the study, it was not possible to ascertain whether the four imaging systems of the hospitals 6a-d are comparable or not, owing to the absence of the data 46 and 48. Therefore, before the start of the study, a planned event 52 was arranged, the event being triggered 3 months after the start of the study. The event 52 has the parameter 16a assigned to it, identifying it as the known planned event.

After the event 52 has been communicated to the collaboration module 18 via the signal path 20, therefore, the collaboration module 18 triggers the process chain predefined in the process module 22, with collaboration specifications:
group 37 of the responsible study personnel is all the radiologists of study 2;
determination of a reference parameter “G” from all the MRI images;
presentation of maxima and minima of “G” and the associated MRI images to the group 37;
clarification by group 37: measured values “G” comparable?
if not, decision about measures;
the timeframe is one week.

The collaboration module 18 then communicates the MRI images 48 from the study database 32 to the integration module 34. Since the parameters “P” 46 are not directly comparable, parameters “G”, which must be the same for all the patients, are determined from all the images. From the parameters “G”, the respectively representative examples and the associated images 48 are selected for each clinic 6a-d and made available to the radiologists 50a-d on the communications platform 36.

In accordance with FIG. 1, the radiologists are contacted and are connected to the communications platform 36 at a favorable time. This does not have to happen simultaneously as they are simply to be provided with all of the data and are to reach an opinion within a week. This task is communicated to them at the same time as the data. Fax connections 54a,b and internet connections 54c,d are used for this.

Towards the end of the week the radiologists 50a-d are simultaneously connected by way of telephone conferencing (lines 54a-d) and discuss whether the imaging systems are comparable. The collaboration system 18 establishes the time by examining the duty rosters of the radiologists 50a-d.

The radiologists 50a-d conclude that the imaging systems differ from one another. This can be remedied, however, by defining various correction factors for image evaluation. A procedure for determining the parameters “P” 46 from the images 48 is communicated to the collaboration system. The latter files the procedure in the study database 32 and orders the evaluation of the images 48 to establish the parameters “P” 46.

Once the result has been established, the collaboration system communicates the result—processed by the integration module 34—of the collaboration 39 via the data line 42 to the study director 10 for the latter's information.

The entire collaboration 39 and the determination of the parameters “P” 46 to be determined from this time on is again monitored, checked, and archived by the monitoring module 44.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for a clinical study, in which an occurrence of an event during the study elicits collaboration between responsible study personnel, the method comprising:
receiving the event at a collaboration system;
identifying, via the collaboration system and on the basis of parameters assigned to the event, a group of responsible study personnel needed for the collaboration;
providing, via the collaboration system, a communications platform for the group to undertake the collaboration;
and
checking, via the collaboration system, the collaboration on the basis of verification criteria.

2. The method as claimed in claim 1, wherein the collaboration system, as a communications platform, provides a central information bus and provides each responsible study personnel member of the group with an information channel to the information bus.

3. The method as claimed in claim 1, wherein
the collaboration system,
ascertains, using the parameters assigned to the event, available data needed for collaboration that are in at least one of a database containing medical knowledge and study database,
extracts the data from the database, and
makes the data available to the group on the communications platform.

4. The method as claimed in claim 1, wherein the collaboration system, using the parameters assigned to the event, establishes a content or time framework for the collaboration and communicates this to the group.

5. The method as claimed in claim 4, wherein the collaboration system uses at least one of content and time framework as a verification criterion and, when the collaboration is over, checks compliance with the verification criteria.

6. The method as claimed in claim 1, wherein a person who was not involved in the study prior to the occurrence of the event is included in the study and in the group, as a responsible personnel member.

7. The method as claimed in claim 1, wherein the event is a prompt for collaboration which is defined within the framework of the study.

8. The method as claimed in claim 1, wherein the event is an unforeseeable event arising during the study.

9. The method as claimed in claim 8, wherein the event is found by a monitoring system combing through the study database data for anything striking.

10. The method as claimed in claim 1, wherein the collaboration is documented.

11. The method as claimed in claim 1, wherein the collaboration is archived.

12. The method as claimed in claim 2, wherein the collaboration system,
ascertains, using the parameters assigned to the event, available data needed for collaboration that are in at least one of a database containing medical knowledge and a study database,
extracts the data from the database, and
makes the data available to the group on the communications platform.

13. The method as claimed in claim 2, wherein the collaboration system, using the parameters assigned to the event, establishes a content or time framework for the collaboration and communicates this to the group.

14. The method as claimed in claim 3, wherein the collaboration system, using the parameters assigned to the event, establishes a content or time framework for the collaboration and communicates this to the group.

15. The method as claimed in claim 2, wherein the event is a prompt for collaboration which is defined within the framework of the study.

16. The method as claimed in claim 2, wherein the event is an unforeseeable event arising during the study.

17. A collaboration system for a clinical study, in which an occurrence of an event during the study elicits collaboration between responsible study personnel, the collaboration system comprising:
means for receiving the event;
means for identifying, on the basis of parameters assigned to the event, a group of responsible study personnel needed for the collaboration;
means for providing a communications platform for the group to undertake the collaboration; and
means for checking the collaboration on the basis of verification criteria.
